(19) United States
(12) Patent Application Publication
(10) Pub. No.: US 2011/0227732 A1
(43) Pub. Date: Sep. 22, 2011

(54) ACCESSORY ACTUATOR

(75) Inventors: Terry Hermanson, New York, NY (US); Meng-Suen Huang, Hong Kong (CN)

(73) Assignee: Mr. Christmas Incorporated, New York, NY (US)

(21) Appl. No.: 12/727,895

(22) Filed: Mar. 19, 2010

(51) Int. Cl. G08B 13/00

(52) U.S. Cl. 340/541

(57) ABSTRACT

An accessory actuator device includes a housing member with an opening. The housing member comprises a detachable front cover, back cover and mounting plate. The actuator activates when a sensor located in the opening senses movement. The sensor then communicates a signal to an accessory activating unit, which in turn activates an indicator unit to output an audio or visual component in the form of a greeting, song and/or flashing lights.

### BACKGROUND OF THE INVENTION

1. Field of the Invention

The present invention relates generally to an accessory actuator, and more particularly to an accessory actuator for use with an existing doorbell button, having a sensor that activates an accessory activating unit to produce an audible or visual indication when a particular stimulus triggers the sensor. For example, the accessory actuator can have a housing member decorated with a holiday theme, which lights up and/or plays a pre-recorded greeting when a person activates a sensor by placing his or her finger in the opening to press an existing doorbell button.

2. Discussion of the Related Art

There are known types of mechanical ornamental actuators which activate a doorbell button. For example, U.S. Pat. No. 5,883,570 relates to a mechanical decorative doorbell actuator, in which a user activates the doorbell by pressing a portion of the decorative doorbell actuator, which causes a push rod to press down on the doorbell button. The doorbell actuator attaches to the wall by first affixing a mounting bracket to the wall near the doorbell, then interlocking a mounting tab with the mounting bracket to affix the actuator. The body of the decorative doorbell actuator attaches to the mounting tab and physically obscures the existing doorbell button.

A drawback to this configuration is that it may be difficult to accurately align the push rod with the doorbell. Because the decorative actuator obstructs the view of the doorbell, it may be difficult to align the push rod to the doorbell button during installation of the actuator. The mechanical elements, such as the mounting tabs and brackets, require precise alignment in order to ensure the decorative actuator contacts the doorbell at a correct position. If the mechanical elements are not properly aligned, the decorative actuator may not reliably actuate the doorbell button. It is difficult for a user to assess whether the decorative actuator is properly aligned because the doorbell button is obscured by the actuator.

Another drawback to this configuration is that since the doorbell button itself is obscured when the decorative actuator is mounted, it is difficult for a user to locate the doorbell button. Conventional doorbell buttons may be equipped with a lighted doorbell button or other indicator that draws the user's attention to the doorbell button, especially during low-light conditions. Thus, completely obscuring the doorbell button by mounting a decorative actuator may make locating the doorbell button during operation problematic, particularly at night.

### SUMMARY OF THE INVENTION

The present invention can provide an accessory actuator that is easily mountable and that does not require the alignment of a push rod to actuate the doorbell button. The present invention allows the doorbell button to be directly actuated by a user. For example, the user may place his or her finger through an opening of the accessory actuator and directly depress the doorbell button.

The present invention can reduce the cumbersome mechanical elements of the related art. The present invention does not require alignment of mounting tabs and brackets with the push rod or other cumbersome mechanical elements in order to actuate the doorbell button. Instead, the doorbell is actuated in a similar fashion as if the accessory actuator device was not present. For example, the doorbell button is actuated by a user pressing the doorbell button directly with his or her finger. Thus, the present invention seeks to reduce the use of such cumbersome and potentially unreliable mechanical elements, allowing the user direct access to the doorbell button.

The present invention can also provide an actuator with a housing comprising a front cover, a back cover and a mounting plate, where the front and back covers are detachable from each other and the mounting plate. This can allow easy access to replace a dead battery, to replace the front cover with a different ornamental design or to access the control panel to adjust the settings of the accessory actuator device.

### BRIEF DESCRIPTION OF THE DRAWINGS

FIG. 1 is a front view of an accessory actuator of the present invention.

FIG. 2 is a rear view of the accessory actuator of the present invention with a view of the mounting plate.

FIG. 3A is an exploded view of a mounted accessory actuator of the present invention.

FIG. 3B is a rear view of the accessory actuator of the present invention with a view of the mounting plate and adhesive elements.

FIG. 4A is view of a front cover detached from the mounting plate of the present invention, with a view of the side of the mounting plate that attaches to the back cover.

FIG. 4B is a view of the back cover detached from the mounting plate of the present invention, with a view of the side of the mounting plate that attaches adjacent the doorbell button.

FIG. 5 is a schematic diagram of one embodiment of electronic elements of the present invention.

FIG. 6 is a schematic diagram of another embodiment of electronic elements of the present invention.

### DETAILED DESCRIPTION

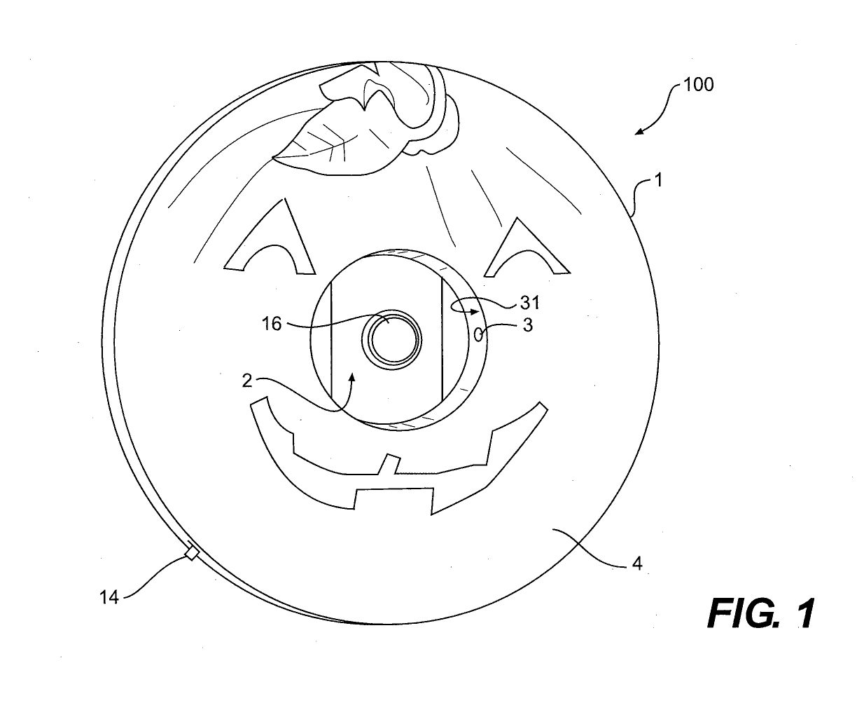

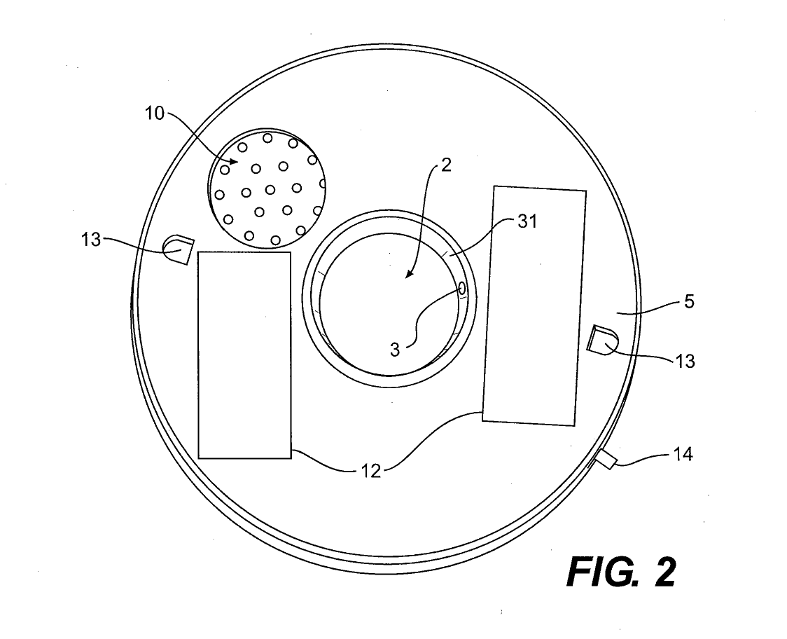

FIGS. 1 and 2 depict a front view and rear view, respectively, of an assembled accessory actuator 100 of the present invention that is ready to be mounted adjacent an existing doorbell button.

Accessory actuator 100 of the present invention comprises a housing member 1 having an opening 2, a sensor 3 and associated electronics. Accessory actuator 100 operates when a user places a finger near opening 2 in order to depress an existing doorbell button 16. Sensor 3 detects the movement of the finger, and interacts with the associated electronics to ultimately produce an audio response, such as a prerecorded greeting, song, message, etc., and/or a visual response, such as flashing lights.

The main body of accessory actuator 100 comprises housing member 1. Housing member 1, having opening 2, comprises a front cover 4, a back cover 6 and a mounting plate 5.

Housing member 1 may be of any shape, for example, a toroid, a cylinder, a hemisphere, etc., to accommodate any type of ornamental design so long as the shape provides an opening 2 for a user to access existing doorbell button 16 and to trigger sensor 3.

Opening 2 may also be of any shape, for example, a circle, triangle, rectangle, etc., so long as the shape does not obscure or obstruct access to the doorbell button. In a preferred but non-limiting embodiment, opening 2 is centrally located in housing member 1.

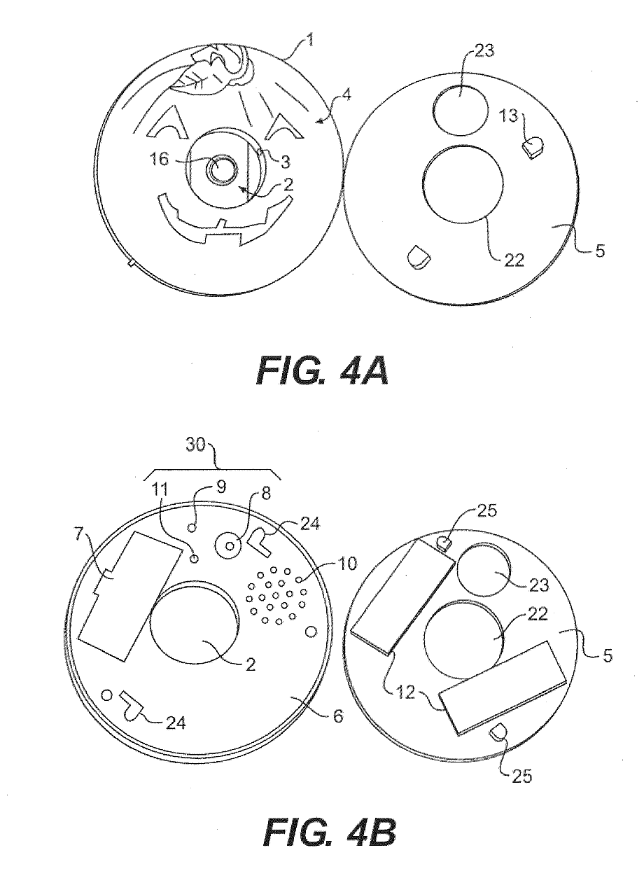

Front cover 4 of housing member 1 accommodates, or is formed as, an ornamental design, such as a Halloween-themed front cover as illustrated in FIGS. 1 and 4A. Front cover 4, however, may accommodate any ornamental design. Other suitable designs for the present invention include a Christmas design, Hanukkah design, birthday design, sports design, animated character design, or any other desired decorative or themed design. Preferably, front cover 4 also houses an on/off switch 14 for powering on and off the accessory actuator device.

With reference to FIG. 4B, back cover 6 of housing member 1 engages with front cover 4 to house the necessary electronic elements of the accessory actuator. Back cover 6 allows a user access to a battery cover 7 in order to replace the battery when necessary. Battery cover 7 is integrated into back cover 6 by any known means. For example, battery cover 7 may be a snap fit type cover that integrates into back cover 6 or it may be a type of cover that is secured using a set of latches or screws. The battery (not shown) is housed within housing member 1 and is accessible via battery cover 7 of back cover 6.

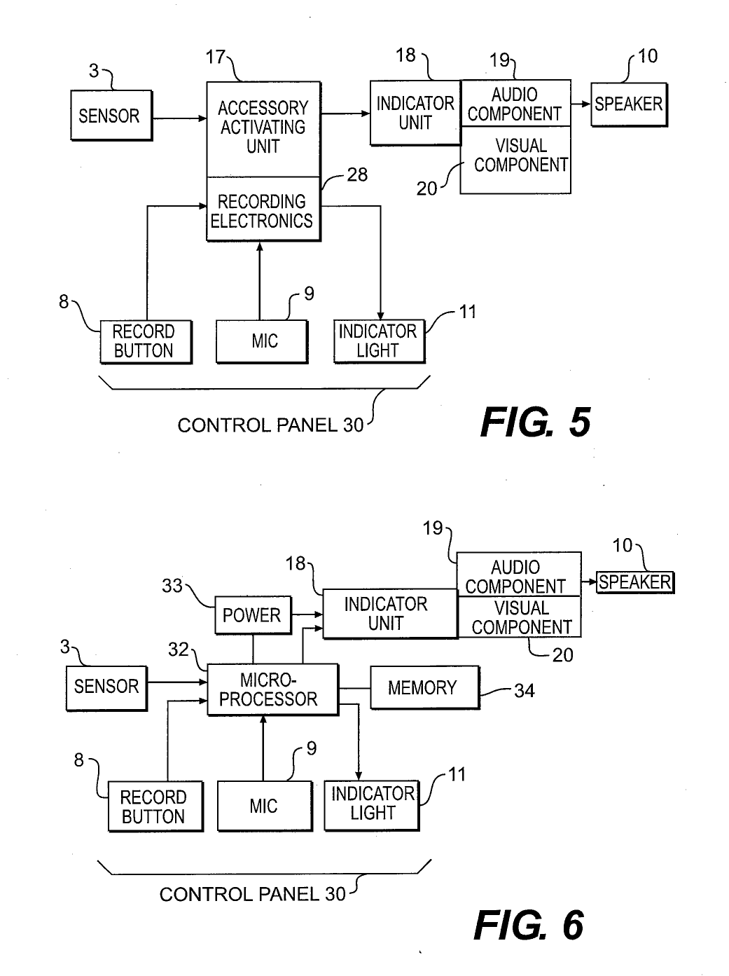

Back cover 6 also provides a user with access to a control panel 30, which permits a user to adjust the settings of the accessory actuator and comprises a record button 8, a microphone 9 and an indication light 11. With reference to FIG. 5, the control panel 30 communicates with recording electronics 28, which communicates with or is part of an accessory activating unit 17. Accessory activating unit 17 is in communication with both sensor 3 and indicator unit 18, which produces the audio and/or visual response.

A user may adjust the settings of accessory actuator 100 by initiating control panel 30. With reference to FIG. 5, in a preferred embodiment, the user can record a greeting by depressing record button 8 to activate recording electronics 28. The user then speaks into microphone 9 and during the recording period, recording electronics 28 activate indication light 11 to indicate to the user that microphone 9 is in use. Microphone 9, receives an audio signal and transduces the audio signal into an audio recording. Once recording is complete, the user releases record button 8 and the recorded message is preserved in an audio component 19 of indicator unit 18. The user may then play back the recording by activating accessory actuator 100 by placing a finger near sensor 3, triggering accessory activating unit 17 to initiate indicator unit 18 to produce the recording. The recording is replayed by outputting to a speaker 10 and may be erased and rerecorded as the user desires.

In another embodiment, control panel 30 may be alternatively controlled via one or more microprocessors, such as central microprocessor 32, as shown in FIG. 6, instead of the recording electronics 28 of FIG. 5. This configuration centralizes control of the all of the accessory electronics instead of having them separately controlled as shown in FIG. 5. The accessory electronics may be controlled by a single microprocessor as illustrated in FIG. 6, by two individual units as shown in FIG. 5 or by any combination of units/microprocessors.

In a preferred embodiment, mounting plate 5, illustrated in FIGS. 2, 3B, 4A and 4B has an engaging means 13 for securing mounting plate 5 to back cover 6. The configuration of the present invention allows a user to secure front cover 4 and back cover 6 to mounting plate 5. FIGS. 4A and 4B illustrate different views of housing member 1 where mounting plate 5 is detached from the rest of housing member 1. The configuration depicted in FIG. 4A shows the side of mounting plate 5 that engages with back cover 6, while the configuration depicted in FIG. 4B illustrates the side of mounting plate 5 that is mounted adjacent doorbell button 16.

Mounting plate 5 also has a first mounting plate opening 22 that is concentric with, and preferably matches the shape and size of, opening 2 of housing member 1. Mounting plate 5 also has a second mounting plate opening 23 to allow sound to freely emit from speaker 10. Mounting plate 5 further comprises adhesive elements 12, which are placed in an area surrounding existing doorbell button 16.

Sensor 3 of accessory actuator 100 is preferably a motion sensor that is triggered when movement of an object is detected. Sensor 3 may be any known type of motion sensor, such as an optical sensor, an electro-optical sensor, a thermal sensor, an infrared sensor, an ultrasonic sensor, a microwave sensor, a video sensor, or any other suitable motion sensor.

With respect to FIGS. 1 and 2, the sensor is positioned on housing 1 preferably within opening 2 on a sensor mounting portion 31 so that only movement within the opening will trigger sensor 3. Sensor 3 may be placed anywhere within opening 2 and on sensor mounting portion 31 so long as the sensor can detect motion within a desired sensing region while also being insensitive to motion outside of the sensing region. In a preferred embodiment, sensor 3 is mounted to sensor mounting portion 31, where sensor mounting portion 31 is a portion of back cover 6. In another preferred embodiment, sensor 3 is mounted to sensor mounting portion 31, where sensor mounting portion 31 is portion of front cover 4.

FIG. 5 schematically illustrates the accessory electronics of the preferred embodiment, which include among other elements, accessory activating unit 17, indicator unit 18, audio component 19, a visual component 20 and recording electronics 28. In a preferred embodiment the accessory electronics are housed within housing member 1 between front cover 4 and back cover 6 and are preferably mounted to back cover 6 by any known electronics mounting means. In another preferred embodiment, the accessory electronics are mounted to front cover 4. In another preferred embodiment, some of the accessory electronics are mounted to front cover 4 and the remainder of the electronics are mounted to back cover 6.

Once sensor 3 is triggered, a signal is sent to accessory activating unit 17, which then activates indicator unit 18, ultimately causing audio component 19 to output a sound and/or visual component 20 to output a visual response, such as a light or set of lights.

Audio component 19 can emit any one of a recorded greeting, song, holiday message or any desired audio recording. These recordings may be modified by the user anytime to adapt to the user's needs. For example, for an accessory actuator with a Halloween design, the user may record a Halloween message such as “Happy Halloween,” which is delivered when the audio component is activated. The user may change the recorded message at a later time to play a Halloween song or scary noises simply by accessing control panel 30 of back cover 6 and re-recording an audio recording.

Visual component 20 may be a single light or an array of lights that are controlled by accessory activating unit 17. The lights may be sequentially activated or timed to coincide with the audio component. For example, a Christmas-themed accessory actuator with a prerecorded audio component such as a Christmas carol may have lights that are illuminated with the beat of the music or in some predetermined fashion. The lights may also illuminate in a pattern separate from the music or may illuminate in an incoherent fashion.

With reference to FIG. 5, in a preferred embodiment, accessory activating unit 17 and recording electronics 28 comprise commonly known electronic circuitry, and may be a single processor chip or a series of units.

With reference to FIG. 6, in an alternative preferred embodiment, the accessory electronics may be centrally controlled by a microprocessor 32. In this embodiment, when sensor 3 is triggered, microprocessor 32 activates the indicator unit 18, which in turn activates audio component 19 and/or visual component 20. Microprocessor 32 also communicates with control panel 30 to effect recording, erasing and playback of the recording. This alternative preferred embodiment of the accessory electronics also includes a power source 33, such as the battery (not shown) to supply power to microprocessor 32 as well as the indicator unit 18. This alternative preferred embodiment of the accessory electronics further includes a memory element 34 for storing recordings.

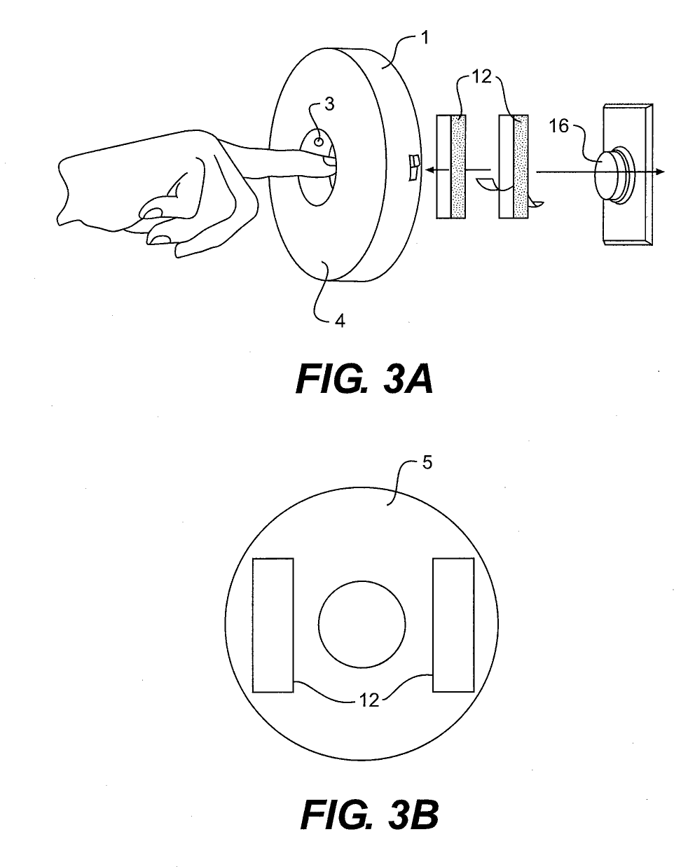

FIGS. 3A and 3B illustrate mounting the accessory actuator device of the present invention. In a preferred embodiment, mounting plate 5 is first adhered or otherwise secured to the area surrounding the doorbell button. Then front cover 4 and back cover 6 are secured to each other via engaging means 13. Front cover 4 and back cover 6 are then mounted to the already secured mounting plate 5.

In a preferred embodiment, adhesive elements 12 are the means by which accessory actuator 100 is mounted to the area adjacent doorbell button 16. In a preferred embodiment, adhesive element 12 is a double sided self-adhesive ethylene vinyl acetate (EVA) foam. Adhesive elements 12 may be adhered first to mounting plate 5 of accessory actuator 100, or in the alternative, the adhesive elements may be adhered first to an area adjacent existing doorbell button 16. The user visually aligns the accessory actuator 100 by aligning existing doorbell button 16 to opening 2 provided within the housing member 1. Adhesive elements 12 have an adhesive material for adhering the mounting plate to the area adjacent the existing doorbell button. Mounting plate 5 may be alternatively mounted to the area adjacent the doorbell button by any affixing means, including screws, nails, tacks, brads, epoxy, glues, other double-sided tapes, etc.

Front cover 4 is joined to back cover 6 in any known manner. In a preferred embodiment, front cover 4 is secured to back cover 6 by a set of screws. In another preferred embodiment, the covers are secured to each other by an adhesive. In yet another preferred embodiment, the covers are secured to each other by forming front cover 4 and back cover 6 such that the covers are frictionally fit or press fit together. Any known means for securing front cover 4 to back cover 6 may be utilized.

Front cover 4 and back cover 6 together are then attached to mounting plate 5 via any known engaging means 13. Engaging means 13 may be a bayonet connector, as shown, a ring mount, or any other known engaging mechanism to secure back cover 6 to mounting plate 5.

In a preferred embodiment, mounting plate 5 is affixed to the area surrounding doorbell button 16 by adhesive elements 12. Then, front cover 4 and back cover 6 are first secured to one another by a set of screws before securing both covers to mounting plate 5. In this embodiment, engaging means 13 comprises a set of engagement tabs 24 and engagement recesses 25, as illustrated in FIG. 4B. The accessory actuator is properly mounted when engagement tabs 24 of back cover 6 are fit within the corresponding engagement recesses 25 of mounting plate 5 and back cover 6 is rotated to engage table 24 with recesses 25. Engagement recesses 25 can be formed by stamping mounting plate 5. Engagement tabs 24 can also be stamped or otherwise formed or affixed to back cover 6. The present invention, however, is not limited by this embodiment as the housing elements may be mounted in any order and by any known mounting method. For example, in another embodiment, after affixing mounting plate 5, back cover 6 may be secured to mounting plate 5 before securing front cover 4 to back plate 6. In yet another embodiment, front cover 4 and back cover 6 are secured together, then a portion of front cover 4 is secured to mounting plate 5.

The present invention does not require alignment of any additional mechanical mounting elements in order to properly align the accessory actuator and, further, does not require a mechanical actuating element, such as the push rod of the related art, to actuate the doorbell button. Instead, the accessory actuator of the present invention may be aligned visually by the user via opening 2 provided in housing member 1. There are no additional mechanical mounting elements; instead, the accessory actuating device is directly mounted to the area adjacent doorbell button 16.

Existing doorbell button 16 may be any common type of doorbell button including 1) an electric doorbell button which is wired to a set of chimes, 2) a wireless doorbell button, where the actuated button sends a wireless signal to a set of chimes, 3) a mechanical doorbell where depressing or pulling the doorbell button mechanically causes the doorbell to chime, or any other type of doorbell button. The accessory actuator of the present invention is configured to be mounted to any type of doorbell button.

Although the specific embodiments of the present invention are directed to an accessory actuator for use with an existing doorbell, the present invention may be applied to a various button-type or switch type devices. For example, the present invention may be used as a decorative element in a push-start ignition in an automobile, a light switch, an elevator button, etc. The present invention may be used as an accessory to any other device that is actuated by a trigger.

Although specific embodiments of the present invention have been described above in detail, it will be understood that this description is merely for purposes of illustration. Various modifications of and equivalent structures corresponding to the disclosed aspects of the preferred embodiments in addition to those described above may be made by those skilled in the art without departing from the spirit of the present invention which is defined in the following claims, the scope of which is to be accorded the broadest reasonable interpretation so as to encompass such modifications and equivalent structures.

What is claimed is:

1. An accessory actuator for use with an existing doorbell button, comprising:
a housing member for mounting adjacent the doorbell button, said housing member including an opening for allowing access to the doorbell button;
a sensor mounted to said housing for sensing movement within the opening; and
an accessory activating unit communicating with said sensor for activating an indicator unit when said sensor senses movement within the opening.

2. The actuator of claim 1, wherein the sensor comprises one of an optical sensor, an electro-optical sensor, a thermal sensor, an infrared sensor, an ultrasonic sensor, a microwave sensor and a video sensor.

3. The actuator of claim 1, wherein said accessory activating unit activates an audio component of the indicator unit when said sensor senses movement within the opening.

4. The actuator of claim 1, wherein said accessory activating unit activates a visual component of the indicator unit when said sensor senses movement within the opening.

5. The actuator of claim 1, wherein said housing further comprises:
a front cover;
a back cover engaging the front cover; and
a mounting plate engaging at least one of the front cover and back cover for mounting the accessory actuator to an area surrounding the doorbell button.

6. The actuator of claim 5, wherein said front cover and said back cover are detachable from the mounting plate.

7. The actuator of claim 1, further comprises a control unit for adjusting settings of the accessory actuator.

8. The actuator of claim 7, wherein the control unit comprises:
a recording button to initiate recording of an audio recording;
a microphone for receiving an audio signal and transducing the audio signal into the audio recording; and
a speaker for outputting the audio recording.

9. An accessory actuator for use with an existing doorbell button, comprising:
housing means for mounting adjacent to the doorbell button, said housing means including an opening for allowing access to the doorbell button;
sensing means for sensing movement within the opening; and
accessory activating means communicating with said sensing means for activating an indicator when said sensing means senses movement within the opening.

10. The actuator of claim 9, wherein said sensing means comprises one of an optical sensor, an electro-optical sensor, a thermal sensor, an infrared sensor, an ultrasonic sensor, a microwave sensor and a video sensor.

11. The actuator of claim 9, wherein said accessory activating means activates an audio component when said sensing means senses movement within the opening.

12. The actuator of claim 9, wherein said accessory activating means activates a visual component when said sensing means senses movement within the opening.

13. The actuator of claim 9, wherein said housing means further comprises:
a front cover;
a back cover mateably connectable to the front cover; and
a mounting plate mateably connected to at least one of the front cover and back cover for mounting the accessory actuator to an area surrounding the doorbell button.

14. The actuator of claim 13, wherein the front cover and back cover are detachable from the mounting plate.

15. The actuator of claim 9, further comprises control means for adjusting settings of the accessory actuator.

16. The actuator of claim 15, wherein said control means comprises:
a recording button to initiate recording of an audio recording;
a microphone for receiving an audio signal and transducing the audio signal into the audio recording; and
a speaker for outputting the audio recording.
